(19) United States
(12) Patent Application Publication
(10) Pub. No.: US 2021/0274996 A1
(43) Pub. Date: Sep. 9, 2021

(54) DISHWASHING APPLIANCE AND DOOR HAVING A BUILT-IN DISPLAY

(71) Applicant: Haier US Appliance Solutions, Inc., Wilmington, DE (US)

(72) Inventors: Kyle James Brewer, Louisville, KY (US); Timothy David Kaiser, Louisville, KY (US); Brian J. Mormon, Louisville, KY (US)

(21) Appl. No.: 16/812,572

(22) Filed: Mar. 9, 2020

(51) Int. Cl. A47L 15/42; F21V 33/00

(52) U.S. Cl. CPC A47L 15/4293; F21V 33/0044; A47L 15/4274; A47L 15/4257

(57) ABSTRACT

A dishwashing appliance, as provided herein, may include door having a frame, an opaque back panel, a light-guide panel, a light source, a transparent liquid crystal display, and an exterior panel. The frame may extend along a transverse direction between a rear internal end and a front external end. The opaque back panel may be mounted to the frame at the front external end. The light-guide panel may be attached to the frame forward from the opaque back panel. The light-guide panel may define a radial edge perpendicular to the transverse direction. The light source may be directed at the radial edge to project a light emission thereto. The transparent liquid crystal display panel may be attached to the frame forward from the light-guide panel. The exterior panel may be attached to the frame forward from the transparent liquid crystal display panel.

### FIELD OF THE INVENTION

The present subject matter relates generally to domestic appliances, such as dishwasher appliances, and more particularly to doors therefor.

### BACKGROUND OF THE INVENTION

Dishwasher appliances generally include a tub that defines a wash chamber for receipt of articles for washing. A door provides or permits selective access to the wash chamber. For example, the door can be rotatably mounted to the wash tub with a hinge. The door can selectively adjust between an open and a closed position by rotating about the hinge in order to permit access to the wash chamber.

In existing appliances, one or more lights are often provided with a control panel as part of a discrete attachment or assembly mounted to a front portion of the door. By illuminating a portion of the door, the lights may generally communicate relevant information regarding the dishwasher appliance. Although such lights may provide useful information, they can often create an unappealing visual impression. Moreover, many existing control panels are difficult to read or interpret. Due, for example, to size constrains, information is presented is often presented in code or on a relatively small display. Attempts have been made to alleviate some of these issues. For instance, some appliances include a lights or a generic liquid crystal display (LCD) at a front surface of a door. Such assemblies may be useful in providing information, but can be unsightly or undesirable, especially when the lights or LCD are not illuminated. For instance, the lights may extend forward from the rest of the door or assembly, interrupting an otherwise smooth surface. Moreover, a user may be able to see where the light or LCD is positioned, even when the light or LCD is not illuminated. Such visual disruptions may cheapen the appearance and perceived quality of the dishwasher appliance. Moreover, the visibility of the region when unilluminated may be distracting and hinder the efficacy of assembly. For instance, a user may take less notice of the light or LCD when illuminated because it is visible even when unilluminated. Furthermore, the visibility of the unilluminated light or LCD may cause confusion for a user, who might believe that the corresponding region is intended to be a button that can be depressed (e.g., in order to control the dishwasher).

As a result, further improvements for dishwasher doors may be desirable. In particular, it would be advantageous to provide a door with a visual indicator or light that would not significantly increase the complexity or space requirements within a door. Moreover, it may be advantageous to provide a door with a visual indicator that would not cause confusion and could enhance the efficacy thereof.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, an appliance door is provided. The appliance door may include a frame, an opaque back panel, a light-guide panel, a light source, a transparent liquid crystal display, and an exterior panel. The frame may extend along a transverse direction between a rear internal end and a front external end. The opaque back panel may be mounted to the frame at the front external end. The light-guide panel may be attached to the frame forward from the opaque back panel. The light-guide panel may define a radial edge perpendicular to the transverse direction. The light source may be directed at the radial edge to project a light emission thereto. The transparent liquid crystal display panel may be attached to the frame forward from the light-guide panel. The exterior panel may be attached to the frame forward from the transparent liquid crystal display panel.

In another exemplary aspect of the present disclosure, a dishwashing appliance is provided. The dishwashing appliance may include a cabinet, a tub, and a door. The tub may be housed within the cabinet and define a wash chamber. The door may be rotatably attached to the cabinet to selectively restrict access to the wash chamber in a closed position. The door may include a frame, an opaque back panel, a light-guide panel, a light source, a transparent liquid crystal display, and an exterior panel. The frame may extend between a rear internal end and a front external end. The opaque back panel may be mounted to the frame at the front external end. The light-guide panel may be attached to the frame forward from the opaque back panel. The light-guide panel may define a radial edge perpendicular. The light source may be directed at the radial edge to project a light emission thereto. The transparent liquid crystal display panel may be attached to the frame forward from the light-guide panel. The exterior panel may be attached to the frame forward from the transparent liquid crystal display panel.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a dishwasher appliance, including a dishwasher door according to exemplary embodiments of the present disclosure.

FIG. 2 provides a side, elevation, sectional view of the exemplary dishwashing appliance of FIG. 1.

FIG. 3 provides a front elevation view of a dishwasher door according to exemplary embodiments of the present disclosure.

FIG. 4 provides a top, sectional side view of a top portion of a dishwasher door according to exemplary embodiments of the present disclosure.

FIG. 5 provides an exploded plan view of plurality of panels of the dishwasher door of FIG. 3.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Terms of approximation, such as “approximately,” “substantially,” or “about,” refer to being within a ten percent margin of error.

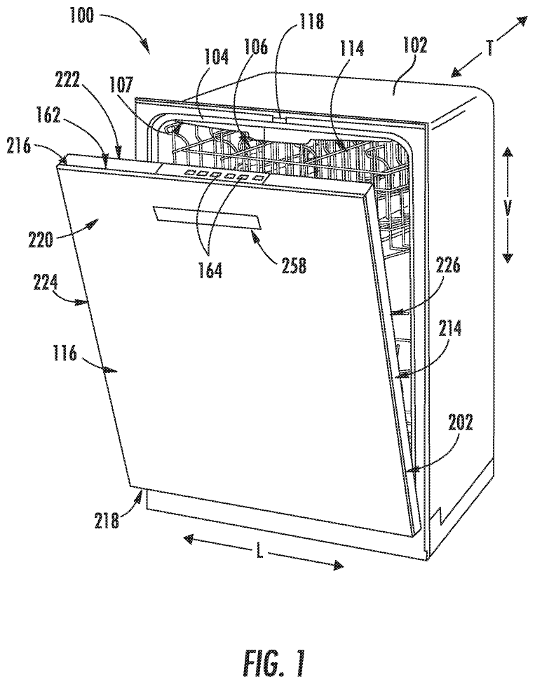

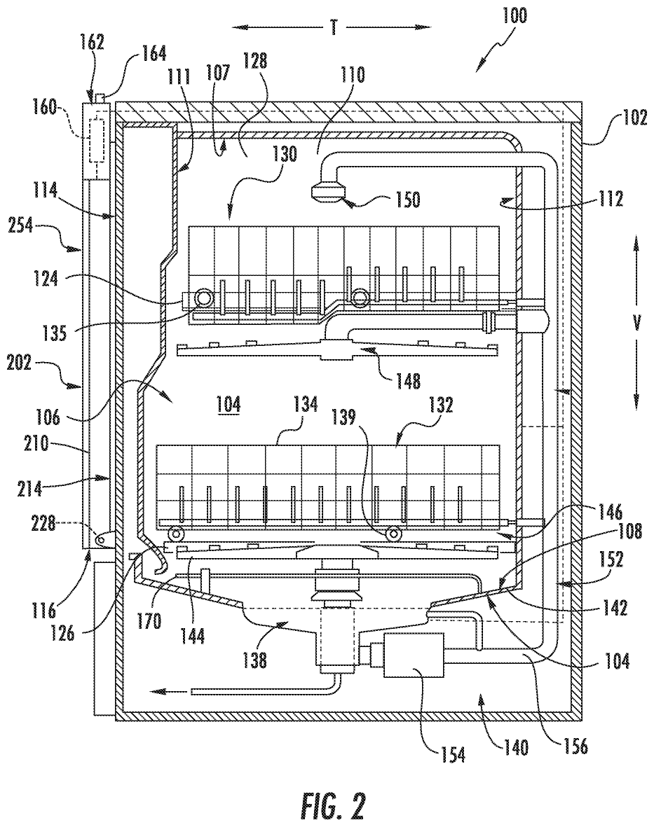

FIGS. 1 and 2 depict an exemplary domestic dishwasher or dishwashing appliance 100 that may be configured in accordance with aspects of the present disclosure. Dishwasher appliance 100 generally includes a cabinet 102 (FIG. 2) having a tub 104 therein that defines a wash chamber 106. As shown in FIG. 2, tub 104 extends between a top 107 and a bottom 108 along a vertical direction V, between a pair of side walls 110 along a lateral direction L, and between a front side 111 and a rear side 112 along a transverse direction T. Each of the vertical direction V, lateral direction L, and transverse direction T are mutually perpendicular to one another and form an orthogonal direction system.

The tub 104 includes a front opening 114. A door 116 may be provided for selectively covering the opening 114. For example, door 116 may be hinged at its bottom for movement between a normally closed vertical position (shown in FIG. 2), wherein the wash chamber 106 is sealed shut for washing operation, and a horizontal open position for loading and unloading of articles from the dishwasher 100. According to exemplary embodiments, dishwasher 100 further includes a door closure mechanism or assembly 118 that is used to lock and unlock door 116 for accessing and sealing wash chamber 106.

As illustrated in FIG. 2, tub side walls 110 may accommodate one or more rack assemblies. Upper and lower guide rails 124, 126 are mounted on tub side walls 110 and accommodate roller-equipped rack assemblies 130 and 132. In optional embodiments, each of the rack assemblies 130, 132 is fabricated as a lattice structure including a plurality of elongated members 134 (for clarity of illustration, not all elongated members forming assemblies 130 and 132 are shown in FIG. 2). Each rack 130, 132 is adapted for movement between an extended loading position (not shown), in which the rack is substantially positioned outside the wash chamber 106, and a retracted position (shown in FIGS. 1 and 2), in which the rack is located inside the wash chamber 106. This rack movement may be facilitated by rollers 135 and 139 that are, for example, mounted onto racks 130 and 132, respectively. A silverware basket (not shown) may be removably attached to rack assembly 132 for placement of silverware, utensils, and the like that are otherwise too small to be accommodated by the racks 130, 132.

In some embodiments, the dishwasher appliance 100 further includes a lower spray-arm assembly 144 that is rotatably mounted within a lower region 146 of the wash chamber 106 and above a tub sump portion 142 so as to rotate in relatively close proximity to rack assembly 132. In exemplary embodiments, such as the embodiment of FIGS. 1 and 2, one or more elevated spray assemblies 148, 150 are provided above the lower spray-arm assembly 144. For instance, a mid-level spray-arm assembly 148 is located in an upper region of the wash chamber 106 and may be located in close proximity to upper rack 130. Additionally or alternatively, an upper spray assembly 150 may be located above the upper rack 130.

The various spray assemblies and manifolds described herein may be part of a fluid distribution system or fluid circulation assembly 152 for circulating water and wash fluid in the tub 104. More specifically, fluid circulation assembly 152 includes a pump 154 for circulating water and wash fluid (e.g., detergent, water, or rinse aid) in the tub 104. Pump 154 may be located within sump 138 or within a machinery compartment located below sump 138 of tub 104, as generally recognized in the art. Fluid circulation assembly 152 may include one or more fluid conduits or circulation piping for directing water or wash fluid from pump 154 to the various spray assemblies and manifolds. For example, as illustrated in FIG. 2, a primary supply conduit 156 may extend from pump 154, along rear 112 of tub 104 along the vertical direction V to supply wash fluid throughout wash chamber 106.

As illustrated, primary supply conduit 156 is used to supply wash fluid to one or more spray assemblies (e.g., assemblies 144, 148, 150). However, it should be appreciated that according to alternative embodiments, any other suitable plumbing configuration may be used to supply wash fluid throughout the various spray manifolds and assemblies described herein.

A heater 170 can be used to provide heat during, e.g., a wash, rinse, or drying cycle. Optionally, heater 170 may be a resistive heating element, such as a type sold under the name CALROD®. Additionally or alternatively, an inline heating element may be provided within fluid circulation assembly 152 to provide heat to wash fluid flowing therethrough.

Each spray-arm assembly 144, 148 includes an arrangement of discharge ports or orifices for directing washing fluid received from the recirculation pump 154 onto dishes or other articles located in rack assemblies 130 and 132. The arrangement of the discharge ports in spray-arm assemblies 144, 148 may provide a rotational force by virtue of washing fluid flowing through the discharge ports. The resultant rotation of the spray-arm assemblies 144, 148 and the operation of the spray assembly 150 using fluid from the recirculation pump 154 provides coverage of dishes and other dishwasher contents with a washing spray. Other configurations of spray assemblies may be used as well.

The dishwasher 100 is further equipped with a controller 160 to regulate operation of the dishwasher 100. The controller 160 may include one or more memory devices and one or more microprocessors, such as general or special purpose microprocessors operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 160 may be constructed without using a microprocessor (e.g., using a combination of discrete analog or digital logic circuitry (such as switches, amplifiers, integrators, comparators, flip-flops, AND gates, and the like) to perform control functionality instead of relying upon software.

The controller 160 may be positioned in a variety of locations throughout dishwasher 100. In the illustrated embodiment, the controller 160 may be located within a control panel area 162 of door 116 as shown in FIGS. 1 and 2. In such an embodiment, input/output (“I/O”) signals may be routed between the control system and various operational components of dishwasher 100 along wiring harnesses that may be routed through the bottom of door 116. Typically, the controller 160 includes a user interface panel or controls 164 through which a user may select various operational features and modes and monitor progress of the dishwasher 100. In some embodiments, the user interface 164 represents a general purpose I/O (“GPIO”) device or functional block. In additional or alternative embodiments, the user interface 164 includes input components, such as one or more of a variety of electrical, mechanical or electro-mechanical input devices including rotary dials, push buttons, and touch pads. As shown, one or more user inputs (e.g., buttons) of user interface 164 may be positioned at a top end 216 of door 116 (e.g., on or through a top wall of door 116). The user interface 164 may include a display component, such as a digital or analog display device designed to provide operational feedback to a user. The user interface 164 may be in communication with the controller 160 via one or more signal lines or shared communication busses.

It should be appreciated that the present disclosure is not limited to any particular style, model, or configuration of dishwasher. The exemplary embodiment depicted in FIGS. 1 and 2 is for illustrative purposes only. For example, different locations may be provided for user interface 164, different configurations may be provided for racks 130, 132, and other differences may be applied as well.

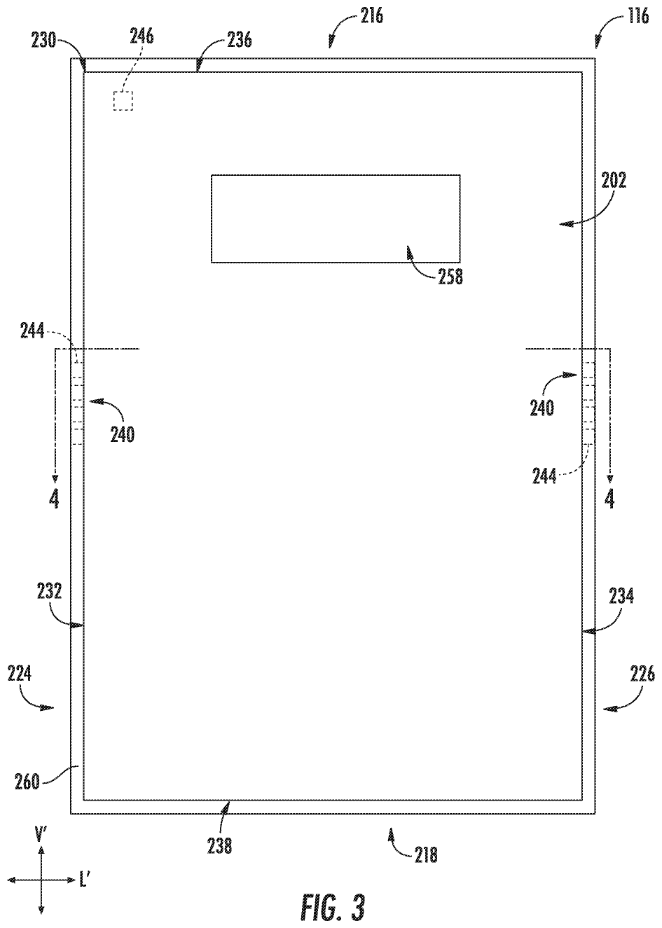

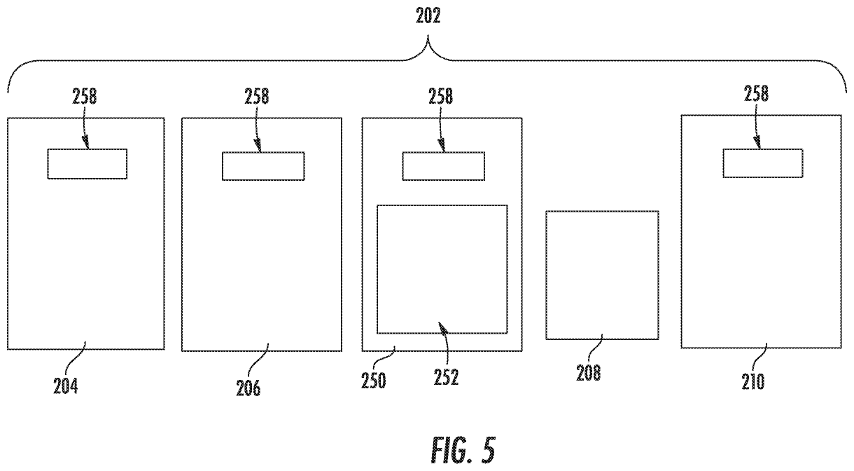

Turning now to FIGS. 3 through 6, a door 116 according to exemplary embodiments of the present disclosure is provided. As described above, it is understood that, door 116 may be mounted on dishwasher appliance 100 (FIG. 1). In turn, the mutually-orthogonal vertical direction V′, lateral direction L′, and transverse direction T′ defined by door 116 and discussed below may be coaxial or otherwise parallel to the vertical direction V, lateral direction L, and transverse direction T, respectively (e.g., when door 116 is in the closed position).

As shown, door 116 includes a panel assembly 202 having a plurality of panels (e.g., opaque back panel 204, light-guide panel 206, transparent LCD panel 208 panel 208, or exterior panel 210) attached to an inner frame 214. Generally, inner frame 214 extends from a top end 216 to a bottom end 218 along the vertical direction V′; from a front external end 220 to a rear internal end 222 (FIG. 1) along the transverse direction T′; and between two lateral ends 224, 226 along the lateral direction L′. A pivot axis 228 may be defined on inner frame 214 (e.g., by one or more lateral pivot hinges or pins), for example, at or proximal to bottom end 218.

When assembled, inner frame 214 extends behind the panel assembly 202 (e.g., along the transverse direction T′). The panel assembly 202 may thus be positioned on front end 220 distal to opening 114 (FIG. 2) while an inner surface of rear end 222 is positioned proximate to opening 114 [e.g., to define a transverse extreme of chamber 106 (FIG. 2) in the closed positioned]. Optionally, some or all of the inner surface of rear end 222 may be formed from a molded plastic or metal sheet to seal opening 114, as would be generally understood. Additionally or alternatively, some or all of the inner frame 214 may be formed from another suitable material, such as glass or wood, to support the inner surface sheet and panel assembly 202. The panel assembly 202 may be fixed relative to inner frame 214 such that panel assembly 202 rotates with inner frame 214 as door 116 moves between the open and closed positions.

In some embodiments, an opaque back panel 204 is mounted to inner frame 214 at the front external end 220. For example, any suitable adhesive, joint, or mechanical fastener (e.g., screw, bolt, clip, bracket, etc.) may be provided to hold opaque back panel 204 to inner frame 214. When assembled, opaque back panel 204 may extend, for example, from the top end 216 to the bottom end 218 and between the two lateral ends 224, 226 in front of inner frame 214. During use, opaque back panel 204 is thus located in front of the opening 114, even when door 116 is in the closed position. Generally, opaque back panel 204 forms a solid, non-permeable surface through which light is prevented from passing (i.e., as would be visually perceptible to a user standing in front of door 116). Opaque back panel 204 may be formed from any suitable material, such as a plastic, metal, coated (e.g., painted) glass, or wood, and may provide a visually-attractive appearance (e.g., as viewed through the other panels of panel assembly 202).

A light-guide panel 206 may be positioned forward from opaque back panel 204 (e.g., along the transverse direction T′). For example, light-guide panel 206 may be attached (e.g., indirectly) to inner frame 214 such that opaque back panel 204 is disposed between light-guide panel 206 and at least a portion of inner frame 214 axially or along the transverse direction T′. Optionally, light-guide panel 206 may be mounted to opaque back panel 204, such as by any suitable adhesive, joint, or mechanical fastener (e.g., screw, bolt, clip, bracket, etc.) may be provided to hold light-guide panel 206 to opaque back panel 204 or inner frame 214.

Light-guide panel 206 may extend, for example, from the top end 216 to the bottom end 218 and between the two lateral ends 224, 226 in front of inner frame 214. As shown, light-guide panel 206 defines a radial edge 230 perpendicular to the transverse direction T′. In particular, radial edge 230 may define the outer bounds of light-guide panel 206 about the transverse direction T′ (i.e., radial maxima). In certain embodiments, light-guide panel 206 may be formed according to a rectangular footprint (e.g., similar to that of the opaque back panel 204, inner frame 214, or door 116, generally). Radial edge 230 may thus include a first vertical segment 232 (e.g., at first lateral end 224) and a second vertical segment 234 (e.g., at second lateral end 226). Radial edge 230 may further include a first lateral segment 236 (e.g., at top end 216) and a second lateral segment 238 (e.g., at bottom end 218), which extend laterally between the first and second vertical segments 232, 234. Between the segments 232, 234, 236, 238 of radial edge 230, light-guide panel 206 may provide a solid, non-permeable body that is generally transparent or translucent such that a user may see opaque back panel 204 through light-guide panel 206. In some such embodiments, light-guide panel 206 is formed from a backlight acrylic [e.g., Poly(methyl methacrylate) (PMMA), such as is provided by ACRYLITE ENDLIGHTEN], which is embedded with a plurality of transparent diffuser particles.

As will be described in greater detail below, a light source 240 [e.g., one or more light emitting diodes (LEDs)] is generally directed at a portion of the radial edge 230 to project a light emission thereto. During use, light emissions may thus be projected radially (e.g., perpendicular to the transverse direction T) through radial edge 230 to the body of light-guide panel 206. Within the body of light-guide panel 206, the at least a portion of the light emissions may subsequently be projected forward (e.g., along the transverse direction T′) through a front surface of light-guide panel 206.

Forward from at least portion of light-guide panel 206, a transparent liquid crystal display (LCD) panel 208 is attached (e.g., indirectly) to inner frame 214. Thus, when assembled, transparent LCD panel 208 may be in front of light-guide panel 206. Moreover, transparent LCD panel 208 may span or cover at least a portion of the footprint or front surface of light-guide panel 206. At least a portion of light-guide panel 206 is, in turn, disposed between opaque back panel 204 and transparent LCD panel 208 axially or along the transverse direction T′. A user viewing door 116 from a forward position may be able to see or visually distinguish opaque back panel 204 through transparent LCD panel 208 and light-guide panel 206.

Transparent LCD panel 208 generally includes a plurality of pixels between two polarizing filters, to selectively move (e.g., as directed by a corresponding electrode set), and thereby permit light through transparent LCD panel 208, as is generally understood. In particular, the light emissions from light-guide panel 206 may advantageously be directed from a front surface of light-guide panel 206 through transparent LCD panel 208, and thus backlight transparent LCD panel 208 (e.g., without requiring a large or relatively brightly-lit volume, as is needed in existing transparent LCD applications).

During use, text or images may be displayed on transparent LCD panel 208. In some such embodiments, light source 240 or transparent LCD panel 208 is operably connected to controller 160. The text or images displayed at transparent LCD panel 208 (or the illumination intensity at which they are displayed) may thus be directed by controller 160. Optionally, a separate sensor (e.g., light sensor 246) may be attached to inner frame 214 (e.g., forward from opaque back panel 204 or rearward from an exterior panel 210). For instance, a light sensor 246 (e.g., infrared sensor) that is configured to detect an ambient light level may be operably connected to controller 160. Controller 160 may be further configured to adjust the intensity (e.g., luminance) directed from light source 240 or permitted through transparent LCD panel 208 based on an ambient light level detected at light sensor 246.

In some embodiments, a transparent substrate 250 is provided about transparent LCD panel 208. For instance, transparent substrate 250 may extend radially about transparent LCD panel 208. Optionally, transparent substrate 250 may extend radially to the top end 216, bottom end 218, first lateral end 224, or second lateral end 226. Additionally or alternatively, transparent substrate 250 may define a thickness (e.g., along the transverse direction T′) substantially equal to a thickness defined by transparent LCD panel 208. In exemplary embodiments, transparent substrate 250 defines an internal void 252 within which transparent LCD panel 208 is received. The internal void 252 may extend fully through transparent substrate 250 (e.g., along the transverse direction T′). Thus, transparent LCD panel 208 may be radially bounded by transparent substrate 250 while being axially unbounded by the same.

An exterior panel 210 may be positioned forward from transparent LCD panel 208 or transparent substrate 250 (e.g., along the transverse direction T′). For example, exterior panel 210 may be attached (e.g., indirectly) to inner frame 214 such that light-guide panel 206 is disposed between exterior panel 210 and at least a portion of transparent LCD panel 208 axially or along the transverse direction T′. Optionally, exterior panel 210 may be mounted to transparent LCD panel 208 or transparent substrate 250, such as by any suitable adhesive, joint, or mechanical fastener (e.g., screw, bolt, clip, bracket, etc.) to hold opaque back panel 204 to inner frame 214.

Exterior panel 210 may be formed from one or more suitable unbent material, such as a transparent plastic material (e.g., acrylic, polycarbonate, etc.) or ceramic material (e.g., glass or glass-ceramic). In some embodiments, exterior panel 210 may be an optically transparent pane. Exterior panel 210 may be generally solid or non-permeable (e.g., such that water is not permitted to pass through a solid body portion of the exterior panel 210). For instance, exterior panel 210 may be a transparent plastic or glass sheet extending from first lateral end 224 to second lateral end 226 or from top end 216 to bottom end 218. Opaque back panel 204 may be visible through exterior panel 210, transparent LCD panel 208, and light-guide panel 206. Moreover, the optically transparent pane of exterior panel 210 may define an outer face 254 of exterior panel 210 as a flat smooth surface. Notably, exterior panel 210 may define an outermost surface that advantageously resists the accumulation of foreign materials (e.g., dirt, grease, etc.) and is relatively easy to clean.

Optionally, a separate touch panel 256 (e.g., capacitive panel) may be mounted across at least a portion of exterior panel 210 (e.g., applied thereon at outer face 254 or an inner-facing surface of exterior panel 210). Such a touch panel 256 may be operably connected to controller 160 and aligned with at least a portion of transparent LCD panel 208 to provide a touch input corresponding to the text or images thereon, as would be understood.

Although one or more of the panels 204, 206, 208, 210 may substantially solid, one or more specific openings may be defined through the panel assembly 202 or inner frame 214. For instance, a front pocket handle opening 258 may be defined through exterior panel 210, transparent substrate 250, light-guide panel 206, or opaque back panel 204 (e.g., along the transverse direction T′). In turn, a user may be permitted to grasp or hold door 116 through pocket handle opening 258 to pivot or otherwise open/close door 116.

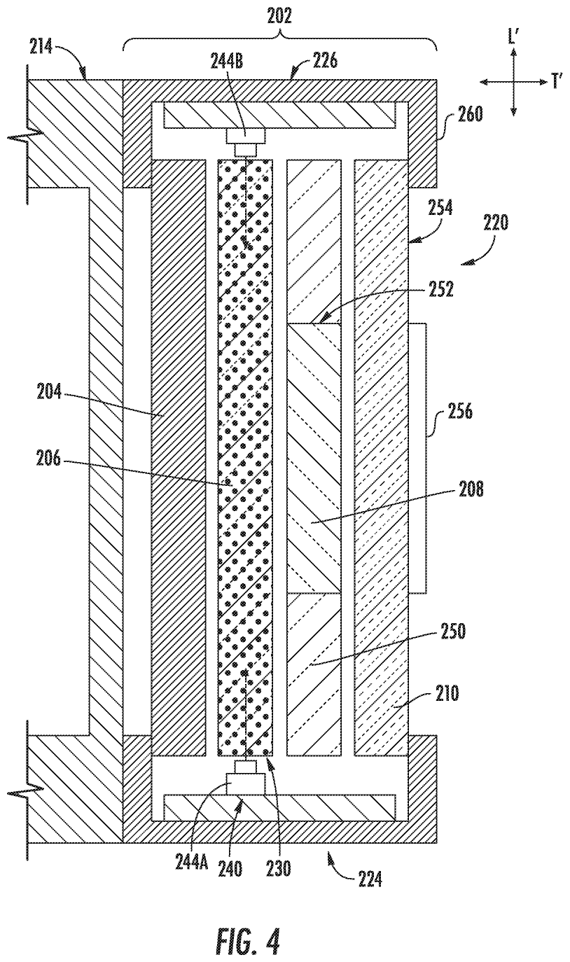

Turning especially to FIGS. 3 and 4, in certain embodiments, panel assembly 202 includes light source 240 in radial alignment with radial edge 230. As shown, light source 240 may include one or more light emitting diodes (LEDs 244) spaced outward from radial edge 230 while being generally disposed at the same location as light-guide panel 206 along the transverse direction T′. Light emissions from the LEDs 244 may thus travel radially and directly into light-guide panel 206 through a portion of radial edge 230. Optionally, multiple of light emitting diodes (LEDs) 244 may be circumferentially apart from each other (e.g., along the lateral direction L′ or the vertical direction V′, as pictured). Additionally or alternatively, the LEDs 244 may be radially aligned with at least a portion of transparent LCD panel 208. Also additionally or alternatively, discrete LEDs 244 may be located at discrete segments (e.g., opposite segments) of radial edge 230. For instance, one or more first LEDs 244A may be directed at a first segment (e.g., first vertical segment 232) while one or more second LEDs 244B are directed at a second segment (e.g., second vertical segment 234).

In optional embodiments, the light source 240 is received within a trim element extending along at least a portion of the radial edge 230. For instance, the one or more LEDs 244 may be housed within a U-channel trim 260 that extends along a corresponding portion of the radial edge 230. Sidewalls of U-channel trim 260 may thus bound the LEDs 244 (e.g., along the transverse direction T′) and further guide or focus light emissions radially inward toward radial edge 230. Optionally, the U-channel trim 260 may extend about the entire radial edge 230. Additionally or alternatively, the U-channel trim 260 may bound the edges of multiple panels (e.g., 204, 206, 208, 210) of panel assembly 202, as shown.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An appliance door defining a mutually-orthogonal vertical direction, lateral direction, and transverse direction, the appliance door comprising:
a frame extending along the transverse direction between a rear internal end and a front external end;
an opaque back panel mounted to the frame at the front external end;
a light-guide panel attached to the frame forward from the opaque back panel, the light-guide panel defining a radial edge perpendicular to the transverse direction;
a light source directed at the radial edge to project a light emission thereto;
a transparent liquid crystal display (LCD) panel attached to the frame forward from the light-guide panel; and p1 an exterior panel attached to the frame forward from the transparent LCD panel.

2. The appliance door of claim 1, wherein the light-guide panel comprises a backlight acrylic.

3. The appliance door of claim 1, further comprising a transparent substrate panel extending radially about the transparent LCD panel, the transparent substrate defining an internal void within which the transparent LCD panel is received.

4. The appliance door of claim 1, wherein the light source is radially aligned with the radial edge.

5. The appliance door of claim 4, wherein the light source comprises a plurality of light emitting diodes (LEDs) spaced apart along the radial edge.

6. The appliance door of claim 4, wherein the light source is radially aligned with the transparent LCD panel.

7. The appliance door of claim 1, further comprising a U-channel trim extending along at least a portion of the radial edge, wherein the light source is received within the U-channel trim.

8. The appliance door of claim 1, wherein the radial edge defines a first segment and a second segment opposite of the first segment, wherein the light source comprises a first LED directed at the first segment and a second LED directed at the second segment.

9. The appliance door of claim 8, further comprising a U-channel trim extending along the first segment and the second segment, wherein the first LED and the second LED are received within the U-channel trim.

10. A dishwashing appliance comprising:
a cabinet;
a tub housed within the cabinet and defining a wash chamber; and
a door rotatably attached to the cabinet to selectively restrict access to the wash chamber in a closed position, the door comprising
a frame extending between a rear internal end and a front external end,
an opaque back panel mounted to the frame at the front external end,
a light-guide panel attached to the frame forward from the opaque back panel such that a rear face of the light-guide panel is blocked by the opaque back panel and the opaque back panel is visible through a front face of the light-guide panel, the light-guide panel defining a radial edge,
a light source directed at the radial edge to project a light emission thereto,
a transparent liquid crystal display (LCD) panel attached to the frame forward from the light-guide panel and the opaque back panel, the transparent LCD comprising a plurality of pixels between two polarizing filters, and
an exterior panel attached to the frame forward from the transparent LCD panel.

11. The dishwashing appliance of claim 10, wherein the light-guide panel comprises a backlight acrylic.

12. The dishwashing appliance of claim 10, wherein the door further comprises a transparent substrate panel extending radially about the transparent LCD panel, the transparent substrate defining an internal void within which the transparent LCD panel is received.

13. The dishwashing appliance of claim 10, wherein the light source is radially aligned with the radial edge.

14. The dishwashing appliance of claim 13, wherein the light source comprises a plurality of light emitting diodes (LEDs) spaced apart along the radial edge.

15. The dishwashing appliance of claim 13, wherein the light source is radially aligned with the transparent LCD panel.

16. The dishwashing appliance of claim 10, wherein the door further comprises a U-channel trim extending along at least a portion of the radial edge, wherein the light source is received within the U-channel trim.

17. The dishwashing appliance of claim 10, wherein the radial edge defines a first segment and a second segment opposite of the first segment, wherein the light source comprises a first LED directed at the first segment and a second LED directed at the second segment.

18. The dishwashing appliance of claim 17, further comprising a U-channel trim extending along the first segment and the second segment, wherein the first LED and the second LED are received within the U-channel trim.

19. A dishwashing appliance comprising:
a cabinet;
a tub housed within the cabinet and defining a wash chamber; and
a door rotatably attached to the cabinet to selectively restrict access to the wash chamber in a closed position, the door comprising
a frame extending between a rear internal end and a front external end,
an opaque back panel mounted to the frame at the front external end,
a light-guide panel attached to the frame forward from the opaque back panel, the light-guide panel defining a radial edge and being translucent such that the opaque back panel is visible through light-guide panel,
a light source radially aligned with and directed at the radial edge to project a light emission into the light-guide panel through the radial edge,
a transparent liquid crystal display (LCD) panel attached to the frame forward from the light-guide panel and the opaque back panel, the transparent LCD comprising a plurality of pixels between two polarizing filters, and
an exterior panel attached to the frame forward from the transparent LCD panel.

20. The dishwashing appliance of claim 19, wherein the door further comprises
a transparent substrate panel extending radially about the transparent LCD panel, the transparent substrate defining an internal void within which the transparent LCD panel is received, and
a U-channel trim extending along at least a portion of the radial edge, wherein the light source is received within the U-channel trim.
